(19) United States
(12) Patent Application Publication
(10) Pub. No.: US 2015/0295933 A1
(43) Pub. Date: Oct. 15, 2015

(54) System and Method for Providing an Early Stage Invention Database

(71) Applicant: Moshe Rogosnitzky, Telz Stone (IL)

(72) Inventor: Moshe Rogosnitzky, Telz Stone (IL)

(21) Appl. No.: 14/686,723

(22) Filed: Apr. 14, 2015

Related U.S. Application Data
(60) Provisional application No. 61/979,180, filed on Apr. 14, 2014.

(51) Int. Cl. H04L 29/06; G06F 17/30

(52) U.S. Cl. CPC H04L 63/101; G06F 17/30371

(57) ABSTRACT

Disclosed is a method of providing an early stage invention database by soliciting a plurality of submitters to provide information data on new inventions prior to or after filing corresponding patent applications, adding the information data to an early stage invention database; and offering the early stage invention database for access by the interested subscribers.

### CROSS REFERENCE TO RELATED APPLICATION

The present Application is related to Provisional Patent Application entitled “System and Method for Providing an Early Stage Invention Database,” filed 14 Apr. 2014 and assigned filing No. 61/979,180, incorporated herein by reference in its entirety.

### FIELD OF THE INVENTION

The present invention relates to a system and method of providing a database of inventions available for patenting and/or licensing and/or investing and/or manufacturing, and more particularly, providing such an invention database as an early-stage invention database.

### BACKGROUND OF THE INVENTION

An inventor who has made a new discovery and wants to obtain a period of marketing exclusivity for his intellectual property typically approaches a patent attorney or agent to file a provisional or non-provisional patent application. Upon securing a filing date for his invention, the inventor can implement, discuss, and market his invention without fear of compromising the patent protection.

However, most countries have patent laws requiring that no formal disclosure of an invention can take place prior to filing a patent application. Otherwise, if there is public disclosure of the invention before the filing date of a patent application, potential patent protection may have been lost for the particular invention. The United States has, until recently, been the exception to this rule, and had permitted filing a patent application within twelve months of public disclosure. Now, the United States has modified patent laws conforming to this global norm.

Thus, a problem exists for an inventor who either is unaware of the reality of losing intellectual property protection through premature public disclosure, or may be aware of the need for timely filing but lacks access to patent attorneys or to funds to complete the patent application process. In the former case, once the inventor has publicly disclosed his invention, he has lost his right to apply for a patent. In the latter case, the inventor is unable to effectively and easily promote his invention to potential funders, who may otherwise have assisted him in filing for IP without the risk of compromising his invention through public disclosure. Present estimates are that up to 90% of valuable discoveries are not patented. In many countries, inventors are totally unaware of the ability to file for patent protection.

Furthermore, even if an inventor were aware of the benefit of filing a patent application, and the invention receives a “patent pending” status, the inventor still faces a major challenge in finding a licensee for his invention. As can be appreciated, the process of seeking a suitable interested licensee is very time consuming and expensive. The licensing process may involve one or more of: (i) extensively researching possible licensees of interest, (ii) corresponding with such parties to gauge their interest in the innovation, (iii) advertising in suitable mediums such as print newsletters or licensor-licensee portals (e.g., Innovaro Pharmalicensing and the Medical Device Licensing website), (iv) travelling to public meetings and exhibitions to present the licensing opportunities, and (v) extensive negotiations of suitable licensing terms.

All of these methods are costly and time consuming, and necessarily limit the number of inventions that are ever actively marketed. In practice it is estimated that only 3% of all patents end up being licensed. This surprising statistic means that up to 97% of issued patents may never get commercially implemented, thus stifling innovation in the respective technical communities.

Due to the above, it would be desirable to have a restricted-access database providing only general information related to such new inventions either in the pre-patent-application phase or post-patent application filing phase, but without the need to wait eighteen months for publication of the patent application, and rely on the more detailed disclosures of the published patent applications. Preferably, the invention database would include topics and descriptive titles of new inventions submitted by the respective inventors. The invention concept submissions could be made at little or no cost to the inventor, the submittal process could involve little or no effort on behalf of the inventor, and the submittals would not include detail so as to constitute a “public disclosure” of the innovation, or the submittals could be governed by non-disclosure agreements, thus not constituting public disclosure.

Such generalized and brief descriptions of the inventions could be submitted at either the earliest point of discovery such as when the inventors seek grant support, or at the point at which the inventor is about to publicly disclose his invention through publication or public presentation. This database would then be accessible by authorized users or subscribers such as, for example: (i) IP attorneys seeking new clientele, (ii) investors seeking very early investing opportunities, (iii) manufacturers seeking to manufacture the invention for the inventor, and (iv) potential licensees seeking candidates to license at the earliest point of discovery.

In the present state of the art, potential licensees may rely on the process of accessing and attending university departments and medical conferences, when seeking new inventions to license. With the advent of the new USPTO patent rules, in which the twelve-month grace period for filing patent applications post publication has been eliminated, there is correspondingly less opportunity for an inventor to seek potential licensees without first having filed a patent application. As a result, it has become immensely more difficult, especially in the United States, for licensors to identify potential licensees and vice versa or for IP attorneys to identify such potential opportunities where they can offer their services to inventors through assisting them with filing for patent protection.

Even if such a restricted access database were available, it would be a major marketing challenge to make many inventors aware of the database's existence. Many inventors are scientists who are not knowledgeable about business processes and awareness of the existence of such a database may be quite limited. Furthermore, even if the inventor were made aware of the existence of such a database, it would require the inventor to invest time in a process whereby the inventor could submit a generalized description of his invention to such a database.

Furthermore, the inventor who has already patented his invention may have such a desire and intention to have his invention included in such an invention database. However, this opportunity would be lost to the inventor who was not well-versed in the patenting opportunity or in the patenting process in general, as the inventor may advertently or inadvertently publicly disclose his invention through publication or through other channels.

WO 01/26002 provides a teaching of a type of database envisioned above by selectively making available previously unpublished or confidential information. The database would be populated with this unpublished or confidential information and this unpublished or confidential information then made selectively available to subscribers of the database. The database taught by WO 01/26002 is intended for entities seeking to license the intellectual property disclosed in the database.

However, WO 01/26002 teaches that the database may be populated by searching for previously unpublished or confidential information on a computer. WO 01/26002 fails to set forth how this unpublished or confidential information is generally obtained from searching on a computer. Also, even if unpublished or confidential information is obtained by searching on a computer, it is unclear how an administrator of this database would involve the owner of this unpublished or confidential information to submit his invention to the database. Considering the confidential nature of this information and the obligation of such databases to strictly maintain confidentiality, it becomes a cumbersome process to contact each inventor and seek their permission to disseminate the unpublished or confidential information.

Additionally, WO 01/26002 provides no disclosure on how the database would be known to owners of unpublished or confidential information so that they could voluntarily submit the unpublished or confidential information and cooperate with the administrator of the database to seek potential licensees of their invention. Further, WO 01/26002 provides no disclosure on how the database of unpublished or confidential information would be marketed to those interested in the unpublished or confidential information, such as patent attorneys or agents seeking to assist the owner with patent protection, or licensees seeking to license the inventor's discovery. Furthermore, the described database in WO 01/26002 is limited to unpublished patent applications. No method is described how unpatented and unpublicized inventions could be collected in such a database.

Thus, an unmet need in the art exists to provide a method of actively soliciting unpublished or confidential information from inventors, or owners of the unpublished or confidential information. It would therefore be desirable to be able to collect unpublished or confidential information via a seamless method, such as soliciting and obtaining this information in the course of another data sharing process, or any other process already being undertaken by the inventor.

### SUMMARY OF THE INVENTION

The invention fulfills this unmet need in the art by providing a method of soliciting unpublished or confidential information from owners of unpublished or confidential information, such as inventors. This method provides for a seamless procedure to enable the owner of unpublished or confidential information, during a process of submitting unpublished or confidential information to a journal for potential publication, or as a funding request for a grant, to simultaneously submit or grant permission for submission of the unpublished or confidential information to a database of unpublished or confidential information accessible to subscribers, such as potential licensees, patent attorneys, agents, investors or invention marketing databases

The owner of unpublished or confidential information or inventor may already be familiar with conventional data sharing processes, and may have contemplated data sharing such as seeking to publicize his invention in a journal or filing a request for funding from a funding agency. By offering a convenient process that would simultaneously file his unpublished or confidential information with a journal or as a grant request and also transmit it to a data sharing database (i.e. for seeking potential licensees or searching for IP licensing databases in which to provide the general concept of his invention to potential investors and partners) it would save the inventor significant time and effort. For the inventor unaware of the possibility or value of patenting, such an opportunity will be created and communicated to the inventor with minimal marketing efforts, as the invention-concept early data sharing method or system is embedded in a process the inventor is already seeking out and desiring to use.

Furthermore, having this simultaneous invention submission method or system would facilitate notifying otherwise uninformed inventors about the opportunities that may exist to obtain IP protection for their inventions. Otherwise, as in the present state of the art, there would be little or no opportunity available for the inventor to make his submission to a database through which the general invention concept could be entered and collected for the restricted invention access portal, prior to the time the more detailed description of the invention information would be made public. The disclosed system and method function: (i) to make such an opportunity available to the inventor thus creating opportunity, saving time and money and enabling financial or other gain, and (ii) to enable the providers of such database to realize a financial gain from the dissemination of the generalized patent or invention concepts.

For example, for life-sciences inventions, there are generally two unique systematic data collection points. One data collection point includes publication in academic journals (or in conference abstracts), in which inventors may publicize their new findings. The other data collection point includes funding agencies to which inventors submit funding requests for research activities related to their inventions.

When a manuscript is submitted for publication in an academic journal, or when a grant application is filed with a funding agency, a short window of opportunity exists within which action can be taken to file a patent application, if no patent application has yet been filed. This window of opportunity typically ranges from several weeks to months, as a manuscript or grant application works its way through the peer/committee review and/or editorial and production process. With grant applications, the window of opportunity may be even longer than for a manuscript publication.

The invention disclosed in this application seeks to take advantage of these windows of opportunity by providing inventors, or owners of unpublished or confidential information, an opportunity to confidentially share details of their information, in an abbreviated or unabbreviated level of detail with potential licensees, patent attorneys, or agents seeking to patent their invention, investors seeking to profit from investing in developing the invention, licensees seeking to license such inventions, or agents, information brokers or database services seeking to market information concerning such inventions.

### BRIEF DESCRIPTIONS OF THE DRAWING

The foregoing aspects, uses, and advantages of the present invention will be more fully appreciated as the same becomes better understood from the following detailed description of the present invention when viewed in conjunction with the accompanying figure, in which:

FIG. 1 is a diagrammatical illustration of an early stage invention database system, in accordance with the present invention.

### DETAILED DESCRIPTION OF THE INVENTION

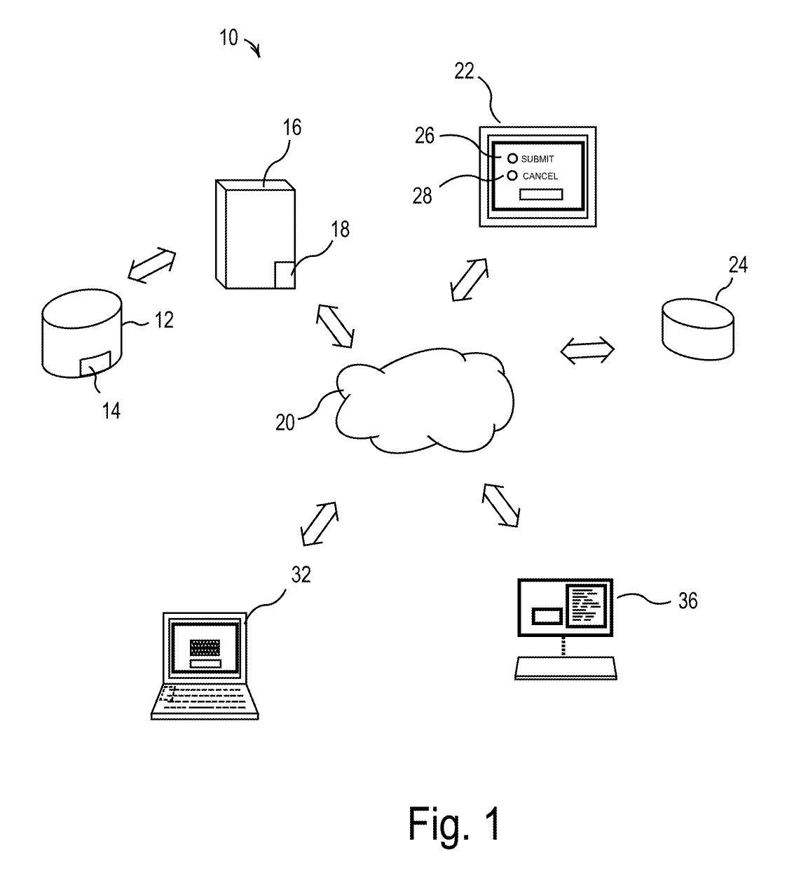

There is shown in FIG. 1 an early stage invention database system 10, in accordance with the present invention. The early stage invention database system 10 comprises an early stage database 12 for storing early stage confidential invention documents 14, such as unpublished manuscripts, pending patent applications, and prosecution documentation related to issued patents. Access to the early stage database 12 may be controlled by an early stage server 16 that executes an early stage invention application 18. A submitter may use a subscriber computer 22, here shown as a computer tablet, to enter confidential information into the early stage database 12 via the Internet 20.

In an exemplary embodiment, the submitter may submit the confidential information, formatted as a technical paper, for example, to a peer-review database 24 belonging to a journal, a research facility, or an institute of higher learning (not shown), for example. The submittal of the confidential information to the peer-review database 24 may be accomplished at substantially the same time as entering the confidential information to the early stage database 12. In an exemplary embodiment, the confidential information can be submitted simultaneously to both the peer-review database 24 and the early stage database 12. As can be appreciated by one skilled in the art, the disclosed method allows the inventor or submitter to maintain confidentiality of the information, while sharing the confidential information with selected recipients who will similarly maintain the confidentiality.

For clarity of disclosure, the following terms are defined in the context of the present application. The term “submitter” is used herein to refer to a party or inventor who may submit or permit to be submitted generalized unpublished or confidential information, regarding a subject invention, during the process of submission of a grant application or during the process of submission of an academic manuscript or an abstract. The term “subscriber” is used herein to refer to a party who seeks access to general information about such newly discovered inventions. The subscriber may access the information in the early stage database 12 via the early stage server 16 using a subscriber computer 32, such as the laptop shown in the illustration. A subscriber may include a biotechnology or pharmaceutical company, a company in another area of industry, an investor, a governmental or non-governmental agency, a patent agent/attorney, another inventor, a manufacturer, an information broker, or an attorney specializing in IP licensing. However the invention is not limited to these entities. Both submitters and subscribers may access the Internet-based early stage invention database system 10 for implementing a method of providing an early stage invention database.

During an information or document submission process, such as may be conducted for the purpose of applying for a grant or for the purpose of publicizing his works as a manuscript in an academic or technical journal or as an abstract at a scientific of business conference, a submitter can take advantage of the opportunity to submit or transmit information on his respective inventions to the early-stage invention database for early stage restricted dissemination. The submitter would be asked a few simple questions which can be answered by simply checking boxes 26, 28, for example. The invention of this application would be implemented by providing these questions in software or utilities the submitter utilizes in applications such as submitting an unpublished manuscript for publication to a technical journal or submitting confidential information for a grant request. These questions to be posed to a submitter may be made available to the submitter by clicking on an electronic link to the early stage invention database provided in the above described software or utilities. Additionally or alternatively, these questions may be posed to a submitter by e-mail immediately after such submitter has undertaken a document submission process, such as may be conducted for the purpose of applying for a grant or for the purpose of publicizing his works as a manuscript in an academic or technical journal, or as an abstract at a scientific of business conference.

Answering these questions would provide the subject matter and contact information of the submitter for inclusion in an appropriate inventor/invention database, which would be subsequently accessed by interested subscribers. The subscribers will then be able to view the topics of such inventions, which may further be categorized to specific subjects or areas of technology, through inventor designated or editor designated “tags.” Depending on the subscription level, a subscriber may have immediate access to view the contact information for the inventor, or may be given the option to purchase access to this information by clicking a link authorizing a charge to a credit card, or a pre-paid or credit-based subscriber account.

In an exemplary embodiment, the inventor, or submitter, may restrict access to their entry in the early stage invention database 12, such that permission may be required from an inventor prior to providing subscriber permission to view contact information or more detailed information about the invention. The subscriber may arrange to talk, meet, or otherwise communicate with a selected inventor or submitter with the goal of establishing a partnership, an investment opportunity, a licensing agreement, or a client for IP filing. The submitter may also select to make the information available only to particular potential licensees, patent attorneys or agents, investors, manufacturers, information brokers or any combination of these parties.

One benefit of the disclosed system is that the new invention data may be added to the early stage database 12 irrespective of the potential outcome of the peer review process for the particular submission or grant request. In the biomedical arena, for example, prestigious journals have an article acceptance rate as low as 5% and funding agencies (such as the NIH) approve as few as 9% of funding requests. Without the present invention, opportunities contained in unpublished manuscripts and non-funded grant requests could be lost to posterity.

By capturing information related to an inventor's innovation at the same time of submission of a manuscript, abstract or funding request, such information can be fed to the early stage database 12 to which interested parties and subscribers have confidential access. This would happen irrespective of the peer-review process, as mentioned above, thus ensuring that all potential discoveries obtain a fair chance at being patented or rapidly finding licensees.

The early stage database 12 is operated in a manner such that the “public disclosure” bar for patents would not be violated by the submitter submitting information to the early stage database 12. Of course, if the submitter has already applied for patent protection, and is just seeking licensing for the invention, and/or investing for, or manufacturing of the invention, the submitter may provide additional disclosure of his invention in greater detail, or make available details of his invention in a manner which would otherwise constitute public disclosure.

It can be appreciated by one skilled in the art that having data related to an inventive concept submitted to the early-stage database 12 provides a logistic advantage to the inventor/submitter. That is, even if the submitter's grant request or manuscript submittal is rejected, as may happen in up to 91% of grant submittals to the NIH, and in up to 95% of the article submittals for journal publications, information related to the inventor's innovation is disseminated to interested parties that may be able to render assistance, funding, services, advice or licensing opportunities to the inventor/submitter.

During a submitter's standard submission process, for example, the respective submission system may obtain specific information on an invention by presenting a submitter, or inventor with a specified number of questions which could be answered by checking a box or clicking or following a link on the software/utility for submitting a manuscript to a technical journal for publication or applying for grant funding, for example, or by otherwise indicating a selection, on a paper form or on the display of the submitter computer 22, or a mobile communication device (not shown) being used by the submitter. In an exemplary embodiment, such questions may include one or more of the following:

The submitter may be presented with an initial question (denoted herein as Question 1) asking if there is already a patent application filed, or an issued patent, for the newly discovered innovation. If the submitter responds in the affirmative, the submitter may be asked to skip the next question (denoted herein as Question 2), and to proceed to the following question (denoted herein as Question 3).

If the submitter has responded in the negative to Question 1, the submitter may be presented with Question 2 asking if, since there is no current patent protection for the subject invention, whether the submitter desires, or would allow, the publishing of any of (i) the submitter name, (ii) the submitter contact information, and/or (iii) the subject or technical field of the newly discovered innovation, in as much detail as the submitter prefers without violating the “public disclosure” bar, in order to solicit or receive offers for assistance with patent protection from a patent attorney or agent. The submitter may also be specifically asked if he would like to make any information about the invention available beyond a title of the invention. Also, the submitter may be asked about the desire to raise money from investors

A question may also be asked regarding the type of information to be made available to the attorney or agent. The submitter may also choose to make his information available to others such as potential licensees, investors and manufacturers. In the diagram, a workstation 36 is shown to represent a computing device used by one of the subscribers such as potential licensees, one of the investors, or one of the manufacturers. The early stage server 16 may function to enable or restrict a subscriber from accessing the database confidential information of the submitter. However, making submitter confidential information available would generally be delayed until a patent application has been filed by the attorney or agent, so that the “public disclosure” bar is not violated by making this information available to others besides a patent attorney or agent.

If the inventor responded in the affirmative to Question 1, the submitter may be presented with Question 3 asking whether the submitter desires, or would allow, the publishing or sharing with subscribers of: (i) the submitter name, (ii) submitter contact information, and/or (iii) the invention in as much detail as the submitter prefers in order to solicit or receive offers for assistance with licensing, manufacturing and/or investment funding. The above information is in addition to any of (i) the general field of the invention, (ii) a title of the invention, (iii) a brief description of the invention, and (iv) patent application number or patent number. At least details (i) through (iv) related to the invention is generally submitted to the database when patent protection is already pending or exists. If a patent document, such as a published application, or an issued patent is related to the invention, this information can also be made available in the database.

Regardless of how the above questions are answered, in an exemplary embodiment, the system may require that any subscriber requesting to see any details of the submitter's invention physically or electronically sign or accept a Non-Disclosure Agreement (NDA) prior to viewing any details of any invention. This may allow a submitter who has not yet filed a patent application to secure funding from an investor, without violating the “public disclosure” bar.

In an exemplary embodiment, the Internet-based early stage invention database system 10 may make the NDA available to the subscriber electronically, or by mail. In an exemplary embodiment, the early stage invention database system 10 may allow the submitter to require all subscribers, or may just require a certain type of subscriber, to contact the submitter electronically or to request the early stage database 12 to do so, in order to request invention details of whatever level of detail the submitter is comfortable. This is done in order to allow the submitter an opportunity to screen certain types of subscribers, or all subscribers, in order to prevent or minimize the possibility of “data mining” or other undesirable activities which may be undertaken to benefit only the subscriber and not the submitter, or of wasting the time of or exposing the identity of the submitter needlessly.

Regardless of how the above questions are answered, in an exemplary embodiment, the submitter may update his disclosed information, or decide to which types of subscribers (e.g., patent agent, or attorneys, other inventors, investors, manufacturers, licensees or information brokers) this information is made available, and the amount of information about the invention, if any, of each type to which the subscriber has access.

The information provided by the individual submitters in answering the above questions would be transmitted to the early stage database 12, formatted, and then be made available for viewing by subscribers (e.g. IP agents or attorneys, potential investors, information brokers, manufacturers, or licensees) who might wish to contact the submitters. Such contact activity may include discussion of proposals as to how the newly discovered invention could be protected by a patent application filing.

In another exemplary embodiment, regardless of how the above questions are answered, the contact information may be withheld from the subscriber. The subscriber may be given the opportunity to make an offer to the submitter through the online early stage database 12. Such an offer may include a brief statement about the subscriber, the subscriber's contact information, and if the subscriber desires, details of the subscriber's proposed offer either relating to invention licensing or to intellectual property protection. This offer could then be forwarded to the submitter, either by email or through an RSS feed, or via a similar method, without the subscriber knowing the identity of the submitter.

Alternatively, an alert may be sent to the submitter either by SMS or by other method of communication to alert the submitter to the presence of a new offer. The alert would provide the submitter access to the information through a link or password on the early stage database 12. For access to this method, a charge may be levied on the submitter for the privilege of viewing the leads that have been transmitted to the database by the subscriber. This charge may be per lead, or per number of leads or per period of time.

In an exemplary embodiment, the disclosed system and method may provide the submitter the option to share generalized information with potential licensees once IP protection has been applied for, via logging into the disclosed system and updating the status of the invention.

In an exemplary embodiment, the disclosed system and method may permit IP licensing attorneys to become potential subscribers, in cases in which a patent application has already been filed for the invention.

In an exemplary embodiment, commercial resources, such as portal services that assist inventors in marketing inventions (e.g., pharmalicensing.com) can be included as potential subscribers.

In an exemplary embodiment, the subscriber may be prohibited from requiring that publication of the applicable invention or grant application be withdrawn if the subscriber has accessed the relevant inventive concept via the database and has entered into negotiations with the inventor.

In an exemplary embodiment, the subscriber may be required to identify a category, or “type of subscriber” to which the subscriber belongs. This category of type of subscriber may include: (i) an IP agent or attorney desiring to assist in patenting the submitter's invention, (ii) an IP attorney desiring to license the submitter's invention, (iii) an investor desiring to invest in the submitter's invention, (iv) a manufacturer desiring to manufacture the submitter's invention, or (v) a potential licensee interested in purchasing or licensing the submitter's invention.

In an exemplary embodiment, the subscriber may view general details of the invention at no cost, if allowed by the system. However, in an alternative embodiment, the subscriber may be required to pay a fee to receive contact information about the submitter, and/or further details of the invention. As previously noted, this fee may be a function of the level of subscription the subscriber has. As also previously noted, in an embodiment, the subscriber may also be required to sign a NDA, or contact the submitter for further details about the invention.

In an exemplary embodiment, the database owner may be provided with a share of any revenue from a licensing or acquisition agreement should such materialize as result of the connection made between the subscriber and submitter.

In an exemplary embodiment, submitters may be charged a fee for requesting their information or invention to be submitted to the early stage invention database.

Changes may be made in the above description without departing from the scope hereof. It should thus be noted that the matter contained in the above description should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method of enabling an inventor to provide early stage invention information to interested subscribers, said method comprising the steps of:
soliciting a plurality of inventors to provide invention descriptions as submitters, prior to public disclosure, said descriptions including generalized concepts of said corresponding inventions;
entering said invention descriptions into an early-stage database, said early-stage database controlled by an early stage server so as to be accessible to selected subscribers, said subscribers being categorized into at least a first type of subscriber and a second type of subscriber;
submitting said invention descriptions to a second database;
determining, from each of said plurality of inventors, whether: (i) a corresponding patent application has been filed, or (ii) an issued patent exists for the corresponding invention;
if, in said step of determining, an affirmative response is given by a responding submitter that a patent application has been filed, said responding submitter acts to provide said generalized concept to said first type of subscriber;
if, in said step of determining, a negative response is given by said responding submitter that a patent application has been filed, each submitter who has responded in the negative acts to provide said generalized concept to a second type of subscriber.

2. The method of claim 1 wherein said step of entering said invention descriptions into an early-stage database is executed at substantially the same time as said step of submitting said invention descriptions to a second database.

3. The method of claim 1 wherein said step of entering said invention descriptions into an early-stage database is executed simultaneously with said step submitting said invention descriptions to a second database.

4. The method of claim 1 further comprising the step wherein each said submitter determines whether a corresponding invention description is made available to said first type of subscriber or to said second type of subscriber.

5. The method of claim 1 further comprising the step of providing payment by a subscriber for access to said early-stage invention database, said payment being a function of a type of subscriber subscription.

6. The method of claim 1 further comprising the step of attaching tags to descriptions of generalized concepts of corresponding inventions for each of said submitters, said tags functioning to facilitate locating an invention of interest.

7. The method of claim 1 wherein said first type of subscriber comprises one of a potential licensee, patent attorneys or agents, an investor, a manufacturer, and an information broker.

8. The method of claim 1 wherein said second type of subscriber comprises one of a patent attorney and a patent agent.
